(19) United States
(12) Patent Application Publication
(10) Pub. No.: US 2021/0385907 A1
(43) Pub. Date: Dec. 9, 2021

(54) COMMUNICATION CONTROL APPARATUS, NON-TRANSITORY COMPUTER READABLE MEDIUM STORING COMMUNICATION CONTROL PROGRAM, AND COMMUNICATION CONTROL SYSTEM

(71) Applicant: FUJIFILM Business Innovation Corp., Tokyo (JP)

(72) Inventor: Ayumi KOBAYASHI, Kanagawa (JP)

(73) Assignee: FUJIFILM Business Innovation Corp., Tokyo (JP)

(21) Appl. No.: 17/037,616

(22) Filed: Sep. 29, 2020

(30) Foreign Application Priority Data
Jun. 4, 2020 (JP) 2020-097787

(51) Int. Cl. H04W 88/06; H04W 84/12; H04W 48/18

(52) U.S. Cl. CPC H04W 88/06; H04W 48/18; H04W 84/12

(57) ABSTRACT

A communication control apparatus includes a processor configured to performs association between a local network slice which is a network slice installed in a network provided by a wireless communication facility and a wide area network segment configured by grouping an external network which is different from the network provided by the wireless communication facility and is used as a dedicated line, sets a transfer path for data transmitted from a terminal using the local network slice, between the local network slice and the wide area network segment.

### CROSS-REFERENCE TO RELATED APPLICATIONS

This application is based on and claims priority under 35 USC 119 from Japanese Patent Application No. 2020-097787 filed Jun. 4, 2020.

### BACKGROUND

### (i) Technical Field

The present invention relates to a communication control apparatus, a non-transitory computer readable medium storing a communication control program, and a communication control system.

### (ii) Related Art

JP2016-100739A discloses a network system including a gateway device set in a network, a physical computer connected to the gateway device, a virtualization unit that allocates computer resources of the physical computer to a plurality of virtual machines, a management computer that manages the physical computer, the virtualization unit, and the gateway device, in which the management computer includes a network mapping unit that sets a virtual network connected to the gateway device and another gateway device via the network, and a VLAN connected to the virtual network, and controls the gateway device, and a virtualization management unit that controls the virtualization unit, based on the setting of the network mapping unit, in which the virtualization unit includes a virtual port connected to the virtual machine, and a virtual switch for setting a VLAN for connecting the virtual port and the gateway device, and in which the gateway device mutually converts communication between the VLAN and the virtual network, based on a command from the network mapping unit, and performs communication with another gateway device connected via the virtual network.

### SUMMARY

In order to construct an intranet for connecting bases by using a fifth generation mobile communication system called “5G”, a gateway device may be constructed on an external network such as WAN to perform transfer control of data.

However, in a case where transfer control is performed by the gateway device, data that has been completely transferred within the same 5G may also be temporarily transmitted to the gateway device, the gateway device may determine the transfer destination, and data may be returned from the gateway device to the 5G from which the data is transmitted.

Therefore, the communication traffic of the WAN is increased due to the data that has been completely transferred within the 5G even without going through the WAN.

Aspects of non-limiting embodiments of the present disclosure relate to a communication control apparatus, a non-transitory computer readable medium storing a communication control program, and a communication control system that can reduce communication traffic in an external network, as compared with a case where a gateway device is installed in an external network connected to a wireless communication facility, and a communication destination is inquired to the gateway device each time communication is performed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a communication control apparatus includes a processor configured to perform association between a local network slice which is a network slice installed in a network provided by a wireless communication facility and a wide area network segment configured by grouping an external network which is different from the network provided by the wireless communication facility and is used as a dedicated line, set a transfer path for data transmitted from a terminal using the local network slice, between the local network slice and the wide area network segment.

### BRIEF DESCRIPTION OF THE DRAWINGS

Exemplary embodiment(s) of the present invention will be described in detail based on the following figures, wherein:

FIG. 1 is a diagram illustrating a system configuration example of a communication control system;

FIG. 2 is a diagram illustrating an example of a transfer policy table;

FIG. 3 is a diagram illustrating a configuration example of a local 5G network;

FIG. 4 is a diagram illustrating a configuration example of an electric system in an orchestrator; and

FIG. 5 is a flowchart illustrating an example of a data transfer path setting process executed by the orchestrator.

### DETAILED DESCRIPTION

Hereinafter, an exemplary embodiment of the present invention will be described in detail with reference to the drawings. The identical components and the identical processes are denoted by the identical reference symbols throughout the drawings, and redundant description will be omitted.

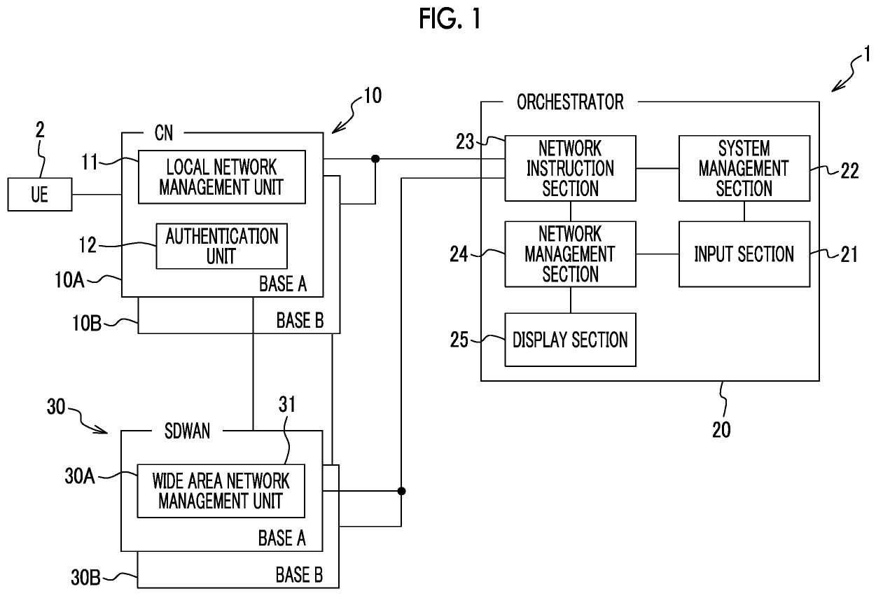

FIG. 1 is a diagram illustrating a system configuration example of a communication control system 1 according to the present exemplary embodiment. The communication control system 1 includes a Core Network (CN) 10 of a fifth generation mobile communication system (hereinafter referred to as “5G system”), an orchestrator connected to the CN 10 via an external network (for example, the Internet or Wide Area Network (WAN)) different from the network provided by the 5G system (hereinafter referred to as “5G network”), and a Software Defined WAN (SDWAN) 30 which is an example of an external network connected to the orchestrator 20 and the CN 10.

The CN 10 is a wireless communication facility including a control device that performs communication control in the 5G system, and is configured by devices used for providing 5G services, such as various exchanges and subscriber information management devices. A terminal used by a user (hereinafter referred to as “UE 2”) and the CN 10 are connected by a wireless communication line provided by a 5G system, and the CN 10 provides the UE 2 with a 5G service.

The 5G network includes a public 5G network that is constructed and operated by a telecommunications carrier, and can be used by any user who contracts with the telecommunications carrier, and a local 5G network that is constructed and operated by an organization such as a company or a municipality other than the telecommunications carrier and can be used only by users within the organization. The CN 10 according to the present exemplary embodiment is classified into a local 5G network.

The CN 10 is constructed in each of bases which are physically separated from each other, such as Tokyo and Osaka. In the case of the example of the communication control system 1 illustrated in FIG. 1, two local 5G networks including a CN 10A constructed at the base A and a CN 10B constructed at the base B are illustrated.

The CN 10 includes a local network management unit 11 and an authentication unit 12.

The authentication unit 12 performs an authentication process for determining whether each UE 2 requesting a connection to the CN 10 is a terminal permitted to connect to the CN 10. In a case where the UE 2 is a terminal permitted to connect to the CN 10, the authentication unit 12 allocates an IP address and a network slice to the UE 2.

The network slice is a technology for virtually dividing resources such as the processing capacity of a facility used for providing 5G services, such as servers and routers, and the bandwidth of the network, and combines the divided virtual resources to construct a virtual network (slice) on the local 5G network between the UE 2 and the CN 10. The network slice constructed on the local 5G network between the UE 2 and the CN 10 is an example of the local network slice according to the present exemplary embodiment. A slice ID for identifying the network slice is allocated to the network slice allocated to the UE 2 in each base, and the recognition and designation of the network slice are performed by using the slice ID. The slice ID is an example of a local slice network identifier.

For example, Mobile Station International Subscriber Directory Number (MSISDN) is used to specify the UE 2 that has requested the connection to the CN 10. MSISDN is a mobile phone number uniquely assigned to the UE 2.

The authentication unit 12 associates the MSISDN of the successfully authenticated UE 2 with the slice ID of the network slice assigned to the UE 2, and transmits the association to the orchestrator 20 to be described later.

In order to connect to the external network, the CN 10 includes a CN router having at least one wireless port to which a network slice in the local 5G network is connected and at least one WAN port to which the external network is connected.

The local network management unit 11 sets Virtual Local Area Network (VLAN) and sets a transfer policy (also called “routing policy”) that defines a data transfer path for the CN router, and constructs a virtual network in which the UE 2 and the external network are connected to each other. The data transfer policy is generated by the orchestrator 20, and the local network management unit 11 sets the data transfer path in the CN router according to the transfer policy received from the orchestrator 20. The CN router is a virtual router configured by software, but may be configured by hardware.

The SDWAN 30 is a wide area communication facility that can be centrally managed through software and controls transfer of data between bases for each UE 2 according to a transfer policy. The SDWAN 30 constructs a virtual network on a physical network by setting routers and the like according to a transfer policy, and realizes secure communication in which bases are connected by a dedicated line. Hereinafter, the virtual network provided by the SDWAN 30 is referred to as a “wide area network (WAN)”.

Like the CN 30, the SDWAN 30 is constructed at each base and is connected to the CN 10 in the base by a LAN cable. In the example of the communication control system 1 illustrated in FIG. 1, there are the SDWAN 30A at the base A and the SDWAN 30B at the base B. Each SDWAN 30 is also connected to the orchestrator 20.

The WAN control device that controls the SDWAN 30 includes a wide area network management unit 31.

The SDWAN 30 is provided with a WAN router having at least one LAN port to which the CN 10 in the base is connected and at least one WAN port to which a wide area network connecting the bases is connected, in order to connect the bases.

The wide area network management unit 31 sets VLAN and Virtual eXtensible Local Area Network (VXLAN) and sets a transfer policy that defines a data transfer path for the WAN router, and constructs a virtual network in which the CN 10 in the base and a CN 10 constructed in another base are connected to each other.

The data transfer policy is generated by the orchestrator 20, and the wide area network management unit 31 sets the data transfer path in the WAN router, according to the transfer policy received from the orchestrator 20. The WAN router is a virtual router configured by software, but may be configured by hardware.

The orchestrator 20 is a communication control apparatus that controls a transfer path of data transmitted from the UE 2 to which a network slice is assigned in the CN 10, and includes an input section 21, a system management section 22, a network instruction section 23, a network management section 24, and a display section 25.

The input section 21 receives the setting content input by the user using an input device such as a keyboard or a mouse, for example, and notifies the system management section 22 and the network management section 24 of the received setting content.

Although there are various types of information in the setting contents, the input section 21 receives from the user the system management information defining the system configuration in the communication control system 1 and the data transfer policy in the communication control system 1, for example.

The system management information includes, for example, respective host names for identifying the CN 10 and SDWAN 30, slice IDs of network slices used in each CN 10, VLAN information set in the CN router and WAN router, and VXLAN information set in the WAN router.

The VLAN information is information for setting a virtual LAN segment configured by grouping network slices independently of the physical connection form of the network. This virtual LAN segment is called a “local network segment”. The VLAN information includes a Virtual LAN IDentifier (VID) that identifies the local network segment to which the network slice represented by the slice ID belongs. That is, the VID is an example of a local network segment identifier. Network slices to which the same VID is assigned belong to the same local network segment.

The VXLAN information is information for setting a virtual WAN segment configured by grouping wide area networks independently of a physical connection form of the network. This virtual WAN segment is called a “wide area network segment”. The VXLAN information includes a VXLAN Network Identifier (VNI) that identifies a wide area network segment to which the wide area network belongs. That is, VNI is an example of a wide area network segment identifier. Wide area networks to which the same VNI is assigned belong to the same wide area network segment.

On the other hand, the transfer policy includes transfer path information of data in which the network slice assigned to the UE 2, the local network segment, and the wide area network segment are associated with each other, and is input to each base.

The input section 21 notifies the system management section 22 of the system management information, and notifies the network management section 24 of the transfer policy.

In a case where the system management section 22 receives the system management information from the input section 21, the system management section 22 stores the system management information and notifies the network instruction section 23 of the system management information, based on the request of the network instruction section 23.

The network instruction section 23 uses the system management information acquired from the system management section 22 to instruct the CN router of each CN 10 represented by the host name to set the VLAN information. Specifically, the network instruction section 23 instructs the local network management unit 11 of the CN 10 to associate the network slice represented by the instructed slice ID with each wireless port of the CN router. Further, the network instruction section 23 instructs the local network management unit 11 of the CN 10 to set the VID associated with each network slice for each WAN port of the CN router and construct a local network segment.

Further, the network instruction section 23 uses the system management information acquired from the system management section 22 to instruct the WAN router of each SDWAN 30 represented by the host name to set the VLAN information and the VXLAN information. Specifically, the network instruction section 23 instructs the wide area network management unit 31 of the SDWAN 30 to set a VID for each LAN port of the WAN router and construct a local network segment, and set VNI associated with the wide area network connected to the WAN port, for each WAN port of the WAN router and construct the wide area network segment.

In addition, the network instruction section 23 acquires the transfer policy for each base received by the input section 21 from the network management section 24, and instructs the CN 10 and the SDWAN 30 of each base to set the transfer policy.

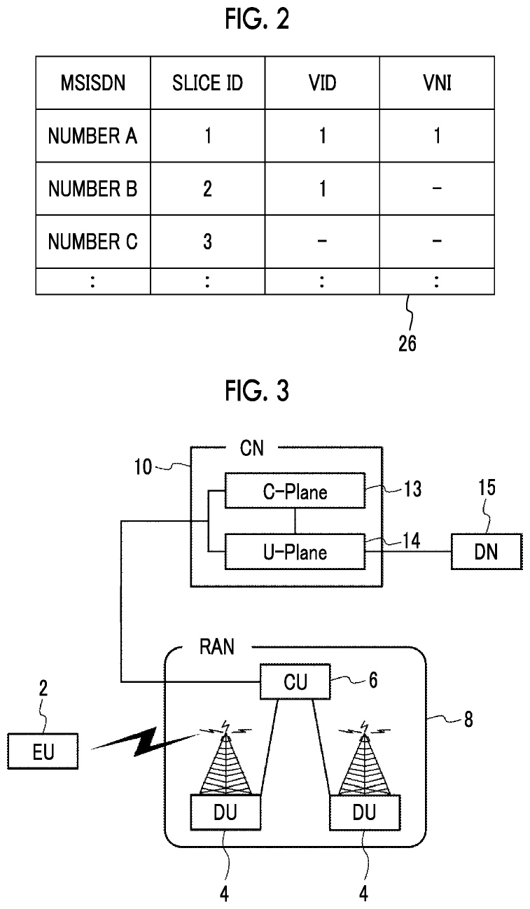

FIG. 2 is a diagram illustrating an example of a transfer policy table 26 defining a transfer policy at a specific base. As illustrated in FIG. 2, the transfer policy table 26 defines a transfer policy that defines a data transfer path by associating a MSISDN, a slice ID, a VID, and a VNI.

The transfer policy in which MSISDN is set to the number A in the transfer policy table 26 of FIG. 2 indicates that “data transmitted to the CN 10 through the network slice represented by the slice ID=“1” is data transmitted from the UE 2 represented by the number A and the VNI is set to “1”, so that the data is transferred from the SDWAN to another base by using the wide area network represented by VNI=“1””. The transfer policy also indicates that “in order to transfer data from the CN 10 to the SDWAN 30, the data of the network slice represented by the slice ID=“1” may be transferred from the WAN port of the CN router in which the VID is set to “1”.

In the transfer policy table 26 of FIG. 2, in the transfer policy in which the MSISDN is set to the number B, the VNI is not set, and the slice ID and the VID are set respectively. Therefore, the transfer policy indicates that “the data transmitted from the UE 2 having the number B to the CN 10 through the network slice represented by the slice ID=“2” may be transferred to the local network segment whose VID is set to “1”” That is, the data transmitted from the UE 2 having the number B is returned within the CN 10 without being transferred to the SDWAN 30, and is transferred to the destination UE 2 belonging to the same local network segment in the same base designated as the destination.

In the transfer policy table 26, “-” means that the value of the corresponding field is not set.

In the transfer policy table 26 of FIG. 2, in the transfer policy in which the MSISDN is set to the number C, the VID and the VNI are not set, and only the slice ID is set. This case indicates that a local network segment to which the data transmitted from the UE 2 having the number C to the CN 10 through the network slice represented by the slice ID=“3” is to be transferred is unknown, so that the data is transferred to the SDWAN 30, which is a higher network for the CN 10, and a solution of the transfer destination is requested. This also indicates that even in the SDWAN 30, the VNI is not associated with the transferred data, a wide area network segment to which the data is to be transferred is unknown, so that the data is transferred to the Internet instead of the wide area network connecting the bases.

The transfer policy table 26 also defines a transfer policy at a base to which data has been transferred from another base.

For example, in a case where the data addressed to the UE 2 in which MSISDN is set to the number A is received from the wide area network segment of VNI=“1”, by referring to the transfer policy in which MSISDN is set to the number A, in the transfer policy table 26 of FIG. 2, the SDWAN 30 transfers the received data, from the WAN port of the WAN router in which VNI=“1” is set, to the LAN port in which VID=“1” is set. Further, in a case where the CN 10 transfers the data received from the WAN port of the CN router in which VID=“1” is set, to the network slice represented by the slice ID=“1”, the data is transferred to the UE 2 to which the number A is assigned.

The association between the MSISDN and the slice ID in the transfer policy is set by the network management section 24 in the transfer policy, according to the association notified to the orchestrator 20 in a case where the authentication of the UE 2 is successful in the authentication unit of the CN 10. Therefore, the user may not associate the MSISDN with the slice ID.

The display section 25 displays the transfer path of the data transmitted from the UE 2 on the display unit 49 described later. With respect to the data transfer path, association between the MSISDN, the slice ID, the VID, and VNI may be displayed as text as in the transfer policy table 26, but may be displayed as a figure such as a line connecting the UE 2, the CN 10, and the SDWAN 30.

Next, the local 5G network including the CN 10 will be described in detail.

FIG. 3 is a diagram illustrating a configuration example of a local 5G network. The local 5G network includes a Radio Access Network (RAN) 8 and a CN 10.

The RAN 8 is a base station network wirelessly connected to the UE 2, and is divided into a Distributed Unit (DU) 4 that provides a wireless antenna function and a Centralized Unit (CU) 6 that provides a base station function. Since the CU 6 is connected to at least one DU 4 and communication with the UE 2 is performed via the DU 4, the DU 4 may be referred to as a distributed node and the CU 6 may be referred to as an aggregation node. The local 5G network may include a plurality of RANs 8.

On the other hand, the CN 10 is configured to include a C-Plane 13 and a U-Plane 14, and the C-Plane 13 and the U-Plane 14 are connected to the CU 6 of each RAN 8.

The C-Plane 13 is a functional unit that performs communication control of the local 5G network, and establishes or disconnects communication with the UE 2. The U-Plane 14 is a functional unit that performs data transfer, and transfers data under the control of the C-Plane 13. Specifically, the Session Management Function (SMF) of the C-Plane 13 performs selection and control of the User Plane Function (UPF) that performs data transfer on the U-Plane 14. That is, the C-Plane 13 controls the U-Plane 14 according to the transfer policy, so that the data transfer according to the transfer policy is realized. As a result of the data transfer control, data that has not been completely transferred in the CN 10 is transmitted to the external network DN 15. The DN 15 includes, for example, the Internet and the SDWAN 30.

Next, a configuration example of an electric system in the orchestrator 20 will be described.

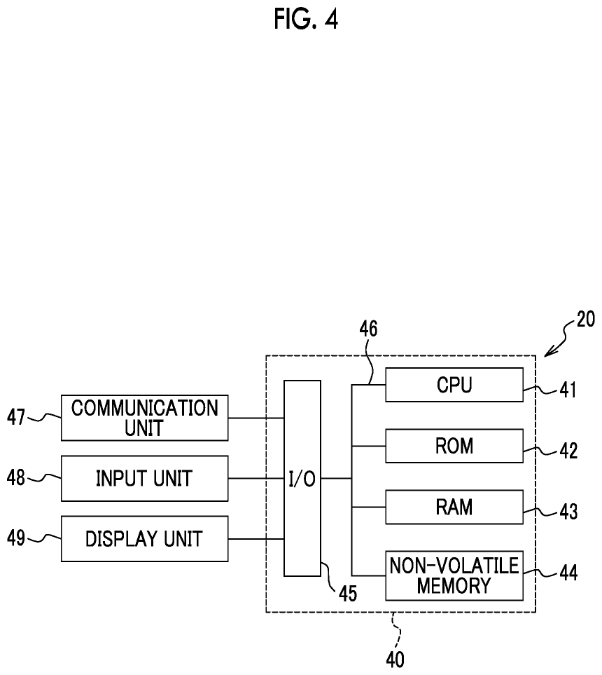

FIG. 4 is a diagram illustrating a configuration example of an electric system in the orchestrator 20. The orchestrator 20 is configured by using a computer 40, for example.

The computer 40 includes a central processing unit (CPU) 41 that performs the process of each functional unit of the orchestrator 20 illustrated in FIG. 1, a read only memory (ROM) 42 that stores a communication control program that causes the computer 40 to function as the orchestrator 20, a random access memory (RAM) 43 used as a temporary work area of the CPU 41, a non-volatile memory 44, and an input/output interface (I/O) 45. The CPU 41, the ROM 42, the RAM 43, the non-volatile memory 44, and the I/O 45 are connected to each other via a bus 46.

The non-volatile memory 44 is an example of a storage device that retains stored information even in a case where power supplied to the non-volatile memory 44 is cut off., and for example, a semiconductor memory is used, but a hard disk may be used. Information that needs to be stored even in a case where the power of the orchestrator 20 is cut off, such as the system management information and the transfer policy table 26, is stored in the non-volatile memory 44.

The non-volatile memory 44 does not necessarily need to be built in the computer 40, and may be, for example, a portable storage device that can be attached to and detached from the computer 40.

For example, a communication unit 47, an input unit 48, and a display unit 49 are connected to the I/O 45.

The communication unit 47 is connected to the DN 15 and has a communication protocol for performing data communication with the CN 10 and the SDWAN 30.

The input unit 48 is a device that receives a user's instruction and notifies the CPU 41 of the instruction. For example, a button, a touch panel, a keyboard, a mouse, or the like is used. In a case of receiving an instruction by voice, a microphone may be used as the input unit 48.

The display unit 49 is an example of a device that visually displays information processed by the CPU 41, and for example, a liquid crystal display, an organic electro luminescence (EL) display, or the like is used. The display section 25 of the orchestrator 20 displays the data transfer path on the display unit 49.

The various units connected to the I/O 45 are examples, and as necessary, a unit different from the unit illustrated in FIG. 4, such as an image forming unit that forms an image on a recording medium such as paper may be connected to the I/O 45. Further, in a case where the orchestrator 20 is installed in an unmanned data center or the like, the input unit 48 and the display unit 49 are not always necessary. In this case, the orchestrator 20 may receive a user's instruction through the communication unit 47, and transmit the information that the orchestrator 20 attempts to display on the display unit 49 to another device through the communication unit 47 and display the information on another device.

Next, the data transfer path setting process in the orchestrator 20 will be described.

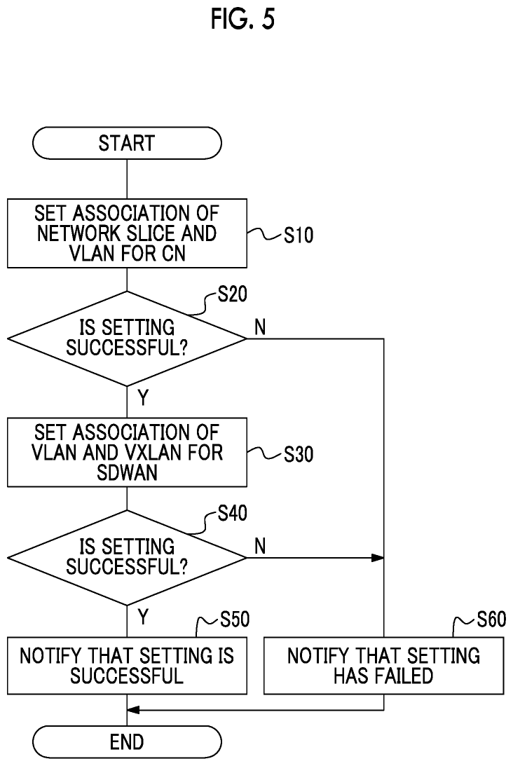

FIG. 5 is a flowchart illustrating an example of a data transfer path setting process executed by the CPU 41 of the orchestrator 20 in a case where a data transfer path setting instruction is received from the user.

The communication control program that defines the data transfer path setting process is stored in advance in the ROM 42 of the orchestrator 20, for example. The CPU 41 of the orchestrator 20 reads the communication control program stored in the ROM 42 and executes the data transfer path setting process.

It is assumed that the non-volatile memory 44 of the orchestrator 20 stores in advance the system management information and the transfer policy table 26 for each base, and the orchestrator 20 sets VLAN information and VXLAN information in the CN 10 and SDWAN 30 of each base, respectively, according to the system management information. Here, as an example, a data transfer path setting process for a specific base will be described.

In step S10, the CPU 41 reads out the transfer policy table 26 from the non-volatile memory 44, and sets the transfer policy represented by the association of the slice ID and the VID for the CN 10, according to the transfer policy table 26. As a result, a transfer path between the slice network and the local network segment is set.

In step S20, the CPU 41 determines whether or not the setting of the transfer policy for the CN 10 in step S10 is successful. The CN 10 notifies the orchestrator 20 of the setting status indicating whether the setting of the transfer policy is successful or not through the external network. Therefore, the CPU 41 refers to the setting status to determine whether or not the setting of the transfer policy for the CN 10 is successful.

In a case where the setting of the transfer policy for the CN 10 is successful, the process proceeds to step S30.

In step S30, the CPU 41 sets the transfer policy represented by the association of VID and VNI for the SDWAN 30, according to the transfer policy table 26 read from the non-volatile memory 44 in step S10. Thereby, the transfer path between the local network segment and the wide area network segment is set.

In step S40, the CPU 41 determines whether or not the setting of the transfer policy for the SDWAN 30 in step S30 is successful. The SDWAN 30 notifies the orchestrator 20 of the setting status indicating whether the setting of the transfer policy is successful or not through the external network. Therefore, the CPU 41 refers to the setting status to determine whether or not the setting of the transfer policy for the SDWAN 30 is successful.

In a case where the setting of the transfer policy for the SDWAN 30 is successful, the process proceeds to step S50.

In this case, since the settings of the transfer policies for the CN 10 and the SDWAN 30 are successful, the CPU 41 displays the setting result indicating that the settings of the transfer policies are successful, on the display unit 49 in step S50, and the data transfer path setting process illustrated in FIG. 5 ends.

On the other hand, in a case where it is determined in the determination process of step S20 that the setting of the transfer policy for the CN 10 has failed, or in a case where it is determined in the determination process of step S40 that the setting of the transfer policy for the SDWAN 30 has failed, the process proceeds to step S60.

In this case, since the transfer policies for both the CN 10 and the SDWAN 30 cannot be set, the CPU 41 displays the setting result indicating that the setting of the transfer policies has failed on the display unit 49 in step S60, and the data transfer path setting process illustrated in FIG. 5 ends.

The CPU 41 does not necessarily need to display the setting result on the display unit 49, and the setting result may be transmitted to another device through the communication unit 47 so that the setting result can be checked by the other device. Further, the CPU 41 may print the setting result on the recording medium by the image forming unit.

In FIG. 5, the data transfer path setting process for a specific base has been described. However, in a case where there are a plurality of bases, the CPU 41 performs the data transfer path setting process illustrated in FIG. 5 for each base, and the data transfer path in each base is set.

The CN 10 for which the transfer policy is set by the orchestrator 20 can determine whether the data is to be returned within the CN 10 or the SDWAN 30 is to be requested, in order to transfer the data to the destination UE 2. Therefore, since the CN 10 requests the SDWAN 30 for transfer control, the process of temporarily transferring the data that needs to be returned in the CN 10 to the SDWAN 30 is not performed.

Further, the transfer policy is set by the orchestrator 20, so that the SDWAN 30 also can determine whether the data is to be transferred to the wide area network or the Internet.

Since VLAN and VXLAN communicate at the second layer (data link layer) represented by “L2” in the OSI reference model, the network between network slices is realized as a virtual L2 network. Therefore, it is not necessary to install and set the L3 switch that transfers data at the third layer (network layer) represented by “L3” in the OSI reference model. Further, the load of the transfer process is lighter and the time required for the transfer process is shorter in a case where the data transfer is performed in the lower L2 than a case where the data transfer is performed in the L3.

In the above, the data transfer path setting process has been described by taking the communication control system 1 that provides the 5G service as an example, but the applicable range of the data transfer path setting process according to the present exemplary embodiment is not limited to the 5G system. It goes without saying that the data transfer path setting process according to the present exemplary embodiment may be applied to any communication system using a network slice, for example, a communication system other than the 5G system, such as a communication system before the 4th generation mobile communication system or a communication system after the 6th generation mobile communication system, which is considered to be introduced.

Although the present invention has been described above using the exemplary embodiment, the present invention is not limited to the scope described in the exemplary embodiment. Various modifications and improvements can be added to the exemplary embodiments without departing from the scope of the present invention, and the exemplary embodiments to which the modifications or improvements are added are also included in the technical scope of the present invention. For example, the order of processes may be changed without departing from the spirit of the present invention.

Further, in the exemplary embodiments, an example has been described in which the data transfer path setting process is realized by software, but the process equivalent to the flowcharts illustrated in FIG. 5 may be mounted on, for example, an application specific integrated circuit (ASIC), a field programmable gate array (FPGA), or a programmable logic device (PLD) and processed by hardware. In this case, the processing speed can be increased as compared with the case where the data transfer path setting process is realized by software.

In this way, the CPU 41 of the orchestrator 20 may be replaced with a dedicated processor specialized for a specific process such as an ASIC, an FPGA, a PLD, a Graphics Processing Unit (GPU), and a Floating Point Unit (FPU).

The process of the orchestrator 20 according to the exemplary embodiment may be realized by one CPU 41 or may be realized by a plurality of CPUs 41. Further, the process of the orchestrator 20 according to the exemplary embodiment may be realized by the cooperation of processors that are physically distant from each other.

Further, in the above-described exemplary embodiments, the aspect in which the communication control program is installed in the ROM 42 has been described, but the exemplary embodiment is not limited to this. The communication control program according to the exemplary embodiment can be provided in a form recorded in a storage medium readable by the computer 40. For example, the communication control program may be provided in a form recorded on an optical disc such as a compact disc (CD)-ROM or a digital versatile disc (DVD)-ROM. Further, the communication control program according to the exemplary embodiments may be provided in a form recorded in a portable semiconductor memory such as a universal serial bus (USB) memory or a memory card.

Further, the orchestrator 20 may acquire the communication control program from another device through the DN 15.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication control apparatus comprising a processor configured to
perform association between a local network slice which is a network slice installed in a network provided by a wireless communication facility and a wide area network segment configured by grouping an external network which is different from the network provided by the wireless communication facility and is used as a dedicated line, and
set a transfer path for data transmitted from a terminal using the local network slice, between the local network slice and the wide area network segment.

2. The communication control apparatus according to claim 1,
wherein the processor is configured to
further associate a local network segment configured by grouping the local network slice with the association between the local network slice and the wide area network segment, and
set a transfer path for data transmitted from a terminal using the local network slice between the local network slice, the local network segment, and the wide area network segment.

3. The communication control apparatus according to claim 2,
wherein the association is defined by an association of a local network slice identifier for identifying the local network slice, a local network segment identifier for identifying the local network segment, and a wide area network segment identifier for identifying the wide area network segment.

4. The communication control apparatus according to claim 1,
wherein the processor is configured to display a transfer path for data transmitted from the terminal on a display device.

5. The communication control apparatus according to claim 2,
wherein the processor is configured to display a transfer path for data transmitted from the terminal on a display device.

6. The communication control apparatus according to claim 3,
wherein the processor is configured to display a transfer path for data transmitted from the terminal on a display device.

7. The communication control apparatus according to claim 1,
wherein the processor is configured not to associate the local network slice used by the terminal with another network segment including the wide area network segment, in a case where the processor transfers the data transmitted from the terminal to an external network different from the wide area network segment.

8. The communication control apparatus according to claim 2,
wherein the processor is configured not to associate the local network slice used by the terminal with another network segment including the wide area network segment, in a case where the processor transfers the data transmitted from the terminal to an external network different from the wide area network segment.

9. The communication control apparatus according to claim 3,
wherein the processor is configured not to associate the local network slice used by the terminal with another network segment including the wide area network segment, in a case where the processor transfers the data transmitted from the terminal to an external network different from the wide area network segment.

10. The communication control apparatus according to claim 4,
wherein the processor is configured not to associate the local network slice used by the terminal with another network segment including the wide area network segment, in a case where the processor transfers the data transmitted from the terminal to an external network different from the wide area network segment.

11. The communication control apparatus according to claim 5,
wherein the processor is configured not to associate the local network slice used by the terminal with another network segment including the wide area network segment, in a case where the processor transfers the data transmitted from the terminal to an external network different from the wide area network segment.

12. The communication control apparatus according to claim 6,
wherein the processor is configured not to associate the local network slice used by the terminal with another network segment including the wide area network segment, in a case where the processor transfers the data transmitted from the terminal to an external network different from the wide area network segment.

13. A non-transitory computer readable medium storing a communication control program causing a computer to execute a process, the process comprising:
performing association between a local network slice which is a network slice installed in a network provided by a wireless communication facility and a wide area network segment configured by grouping an external network which is different from the network provided by the wireless communication facility and is used as a virtual dedicated line, and
setting a transfer path for data transmitted from a terminal using the local network slice, between the local network slice and the wide area network segment.

14. A communication control system comprising:
a wireless communication facility that permits connection only to a predetermined terminal;
a wide area communication facility, which is connected to the wireless communication facility by a line and whose communication is controlled by software; and
a communication control apparatus that sets association between a local network slice which is a network slice installed in a network provided by the wireless communication facility and a wide area network segment configured by grouping an external network which is different from the network provided by the wireless communication facility and is used as a dedicated line, in the wireless communication facility and the wide area communication facility, and controls a transfer path of data transmitted from a terminal that uses the local network slice.
